(19) United States
(12) Patent Application Publication
(10) Pub. No.: US 2006/0244419 A1
(43) Pub. Date: Nov. 2, 2006

(54) Portable computing device with power packs

(75) Inventor: Robert D. Palmquist, Faribault, MN (US)

Correspondence Address: SHUMAKER & SIEFFERT, P. A., 8425 SEASONS PARKWAY, SUITE 105, ST. PAUL, MN, 55125, US

(73) Assignee: Speechgear, Inc., Northfield, MN (US)

(21) Appl. No.: 11/221,404

(22) Filed: Sep. 7, 2005

Related U.S. Application Data
(60) Provisional application No. 60/608,235, filed on Sep. 8, 2004.

(51) Int. Cl. H02J 7/00

(52) U.S. Cl. 320/114

(57) ABSTRACT

The invention is directed to systems that include a portable computing device comprising a first cover member hingedly coupled to a second cover member, and at least two portable power packs. The power packs are configured to detachably electrically couple to the underside of at least one of the cover members. The user has the option to select one or more power packs that provide the features that the user desires.

This application claims the benefit of U.S. Provisional Application Ser. No. 60/608,235, filed Sep. 8, 2004, the entire content of which is incorporated herein by reference.

### STATEMENT REGARDING FEDERALLY SPONSORED RESEARCH FOR DEVELOPMENT

This invention was made with Government support under Contract N00014-03-C-0368 awarded by Office of Naval Research. The Government may have certain rights in this invention.

### TECHNICAL FIELD

The invention relates to portable computing devices that use portable power packs.

### BACKGROUND

Portable computing devices, such as personal digital assistants, “pocket” personal computers, laptop personal computers and notebook personal computers, often include a portable power source such as a battery pack. When a user operates the portable computer in a venue that lacks a plug-in power source, the portable computer may rely on the portable power source for power.

To save space and to protect the input and output devices incorporated in the portable computers, many portable computers include two cover members that are hingedly coupled to one another. When a user opens the portable computer by swinging the cover members apart, the user obtains access to the input and output devices of the portable computer, such as a display, keyboard and touch screen.

Many portable power sources are designed to save weight and space. In some circumstances, the power sources trade energy storage capacity or other qualities for savings of weight or space.

### SUMMARY

In general, the invention is directed to systems that include a portable computing device and at least two portable power packs. The invention gives the user the option to select one or more power packs that provide the features that the user desires. For example, the user may select a thicker or heavier power pack that has a large energy storage capacity. In other words, the user can choose to take on added size and weight in exchange for more energy storage capacity. In circumstances in which size and weight are important, the user may select a thinner and lighter power pack.

Various other power packs may have other “power pack qualities” that provide various other advantages, and the user may select a power pack that includes the advantages that the user finds more desirable. The user can select a power pack that is suited to the environment in which the portable computer will be used, for example, or suited to the functions that the portable computer will be called upon to perform.

In one embodiment, the invention is directed to a system that includes a portable computer comprising a first cover member hingedly coupled to a second cover member. The system also includes at least two power packs, with one power pack being thicker than the other. The power packs are configured to detachably electrically couple to the underside of the first cover member.

In another embodiment, the invention presents a system comprising a portable computer comprising a first cover member hingedly coupled to a second cover member, a first power pack comprising a first power pack quality and a second power pack comprising a second power pack quality. The first and second power packs are configured to detachably electrically couple to the underside of the first cover member.

In a further embodiment, the invention is directed to a system comprising a portable computer comprising a first cover member hingedly coupled to a second cover member, a first power pack configured to detachably electrically couple to the underside of the first cover member and a second power pack configured to detachably electrically couple to the underside of the second cover member.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective diagram illustrating system including a portable computer and a first power pack.

FIG. 2 is a perspective diagram illustrating the system of FIG. 1, with the portable computer coupled to the first power pack.

FIG. 3 is a perspective diagram illustrating a system with the portable computer of FIG. 1 coupled to a second power pack.

FIG. 4 is a perspective view of an underside of a power pack such as the power pack shown in FIGS. 1 and 2.

FIG. 5 is a perspective diagram illustrating system including a portable computer and a first power pack and a second power pack.

### DETAILED DESCRIPTION

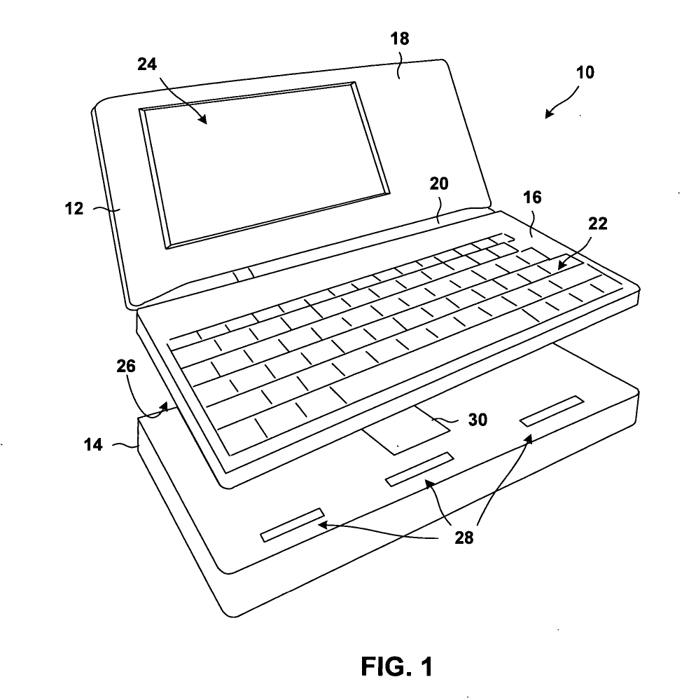

FIG. 1 is perspective view of a system 10 that includes a portable computer 12 and a power pack 14. Portable computer 12 includes a first cover member 16 and a second cover member 18 hingedly coupled together by a hinge member 20. In the embodiment shown in FIG. 1, first cover member 16 includes an input device such as a keyboard 22 and second cover member 18 includes an output device such as a display screen 24.

Portable computer 12 is used to illustrate aspects of the invention, but the invention is not limited to the particular portable computer that is shown in the figures. The invention may be applied to portable computers of many kinds, including handheld computing devices such as personal digital assistants, “pocket” personal computers, laptop personal computers, notebook personal computers and the like. The invention includes embodiments in which the first cover member includes a keyboard and the second cover member includes a display screen. The invention further includes embodiments in which input and output devices are housed in first cover member 16, and in which second cover member 18 includes no electronic components.

First cover member 16 includes an underside 26, that is, a side that does not include devices that a user would operate in the ordinary course of operating portable computer 12. Power pack 14 couples to underside 26 of first cover member 16. Power pack 14 includes one or more mating elements 28 such as slots, latches, snaps and the like, which mechanically couple power pack 14 to underside 26 of first cover member 16. Underside 26 can include complementary mating elements (not shown) that engage mating elements 28. Mating elements 28 prevent first cover member 16 and power pack 14 from inadvertently disengaging from one another. In addition, power pack 14 includes one or more electrical contacts 30, which electrically couple power pack 14 to first cover member 16.

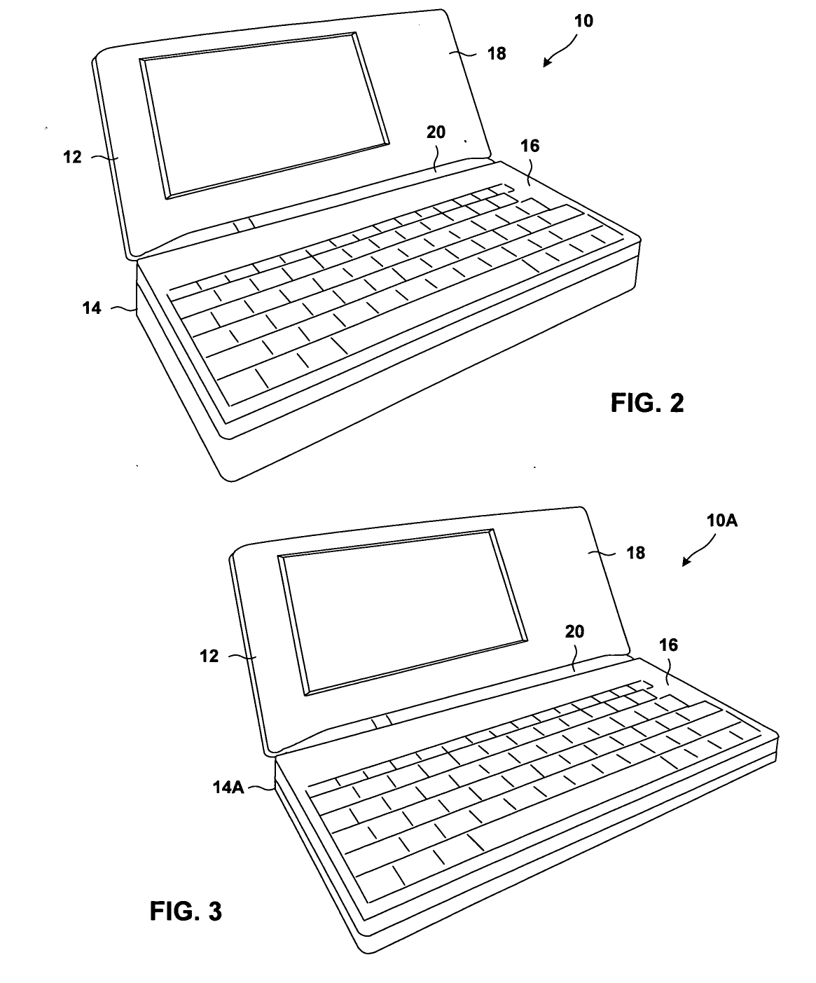

FIG. 2 is a perspective drawing showing power pack 14 coupled to first cover member 16. Power pack 14 is detachable from first cover member 16. In other words, a user can engage power pack 14 with first cover member 16, and mating elements 28 will hold power pack 14 in place, as shown in FIG. 2. The user can also disengage power pack 14 from first cover member 16. As shown in FIG. 2, the “footprint” of power pack 14 is comparable to that of first cover member 16, so that power pack 14 does not require any extra desk space, lap space or other surface space. The invention also supports embodiments in which power pack 14 has a footprint that is substantially different from that of first cover member 16.

Power pack 14 supplies power to portable computer 12. Power pack 14 can include one or more portable power sources, including but not limited to various battery chemistries, fuel cells, capacitors, solar cells or any combination thereof. Power pack 14 can be rechargeable or disposable.

Power pack 14 is useful for users that use their portable computers in venues that offer little or no access to a plug-in power source. It is common, in some venues, for many users to use their portable computers for extended periods of time. In other venues, however, users may use their portable computers for much shorter periods of time. As a result, there may be times when a user may desire a power pack with a larger energy storage capacity, and there may be times when the power pack need not have a large energy storage capacity.

FIG. 3 is perspective view of a system 10A that is similar to system 10 shown in FIGS. 1 and 2. In FIG. 3, first cover member 16 of portable computer 12 is coupled to a second power pack 14A. Physically, power pack 14 shown in FIGS. 1 and 2 is thicker than second power pack 14A. The smaller dimensions of second power pack 14A may make second power pack 14A desirable in some circumstances, such as circumstances in which it is important to save space and weight.

The invention is not limited to application with two power packs. The invention supports more than two power packs having differing dimensions. The invention supports, for example, a system in which a portable computer can couple to a thin power pack, a medium power pack and a thick power pack, according to the preferences of the user.

Power packs 14 and 14A may differ in respects in addition to dimension. In a typical application, thicker power pack 14 has a larger large energy storage capacity than power pack 14A. The invention also supports embodiments in which power packs 14 and 14A differ in ways other than or in addition to energy storage capacity. In alternate embodiments, power packs 14 and 14A differ in one or more specifications or “power pack qualities.”

As used herein, “power pack qualities” pertain to the capability of the power packs to provide power to personal computer 12. One power pack quality is energy storage capacity. Power packs 14 and 14A may have differing amp-hour ratings, for example. Another power pack quality is energy management, which pertains to the way in which a power pack provides useful energy to portable computer 12. For purposes of illustration, one power pack may apply one battery chemistry, and another power pack may apply a different battery chemistry. One power pack may include conventional batteries, another may utilize high-storage capacitors, and still another may use solar cells. Another power pack quality is rechargeability. One power pack may be rechargeable and another disposable. One power pack may be quickly rechargeable while the other may require a longer recharge time. A further power pack quality is environmental operating specifications, or the capability of operating under different environmental conditions. One power pack may be more useful in colder weather, for example, while another power pack may be more useful in warmer weather.

The above power pack qualities are illustrative and the invention is not limited to those particular power pack qualities. In general, the difference in power pack qualities can empower a user to select among power packs having desirable size, weight, and power pack qualities. Power pack 14A may be thinner, less bulky, and not as heavy as power pack 14, for example, but power pack 14 may have significantly larger energy storage capacity or other power pack qualities that make it more desirable in certain situations.

In those situations in which the user wishes to take advantage of the desirable power pack qualities of power pack 14, the user can couple power pack 14 to portable computer 12. In those situations in which the user wishes to take advantage of the desirable power pack qualities of power pack 14A, the user can disengage power pack 14 from portable computer 12 and couple power pack 14A to portable computer 12.

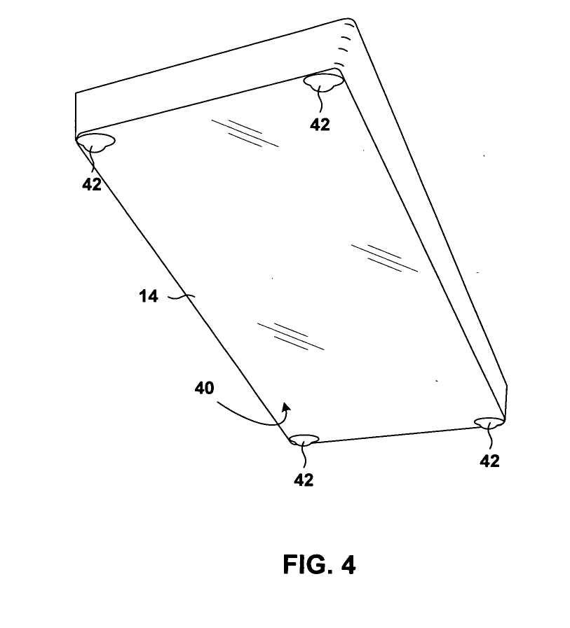

FIG. 4 is a perspective view of an underside 40 of power pack 14. Underside 40 is substantially flat, but includes one or more spacers 42 that extend away from underside 40. As shown in FIG. 4, power pack 14 includes four spacers deployed on the corners, but the invention supports any number of spacers in any deployment.

In one variation, spacers 42 may be constructed of a soft polymer or rubber, and may be attached to underside 40 with adhesive. In another variation, spacers 42 may be protrusions formed from the same material that makes underside 40 of power pack 14.

When a user places system 10 on a surface such as a desk, spacers 42 can protect the surface from scuffing and can also keep system from sliding. In addition, spacers also create an airspace between underside 40 and the surface. In some applications, the airspace can improve heat management and can reduce the risk of heat from power pack 10 affecting the surface.

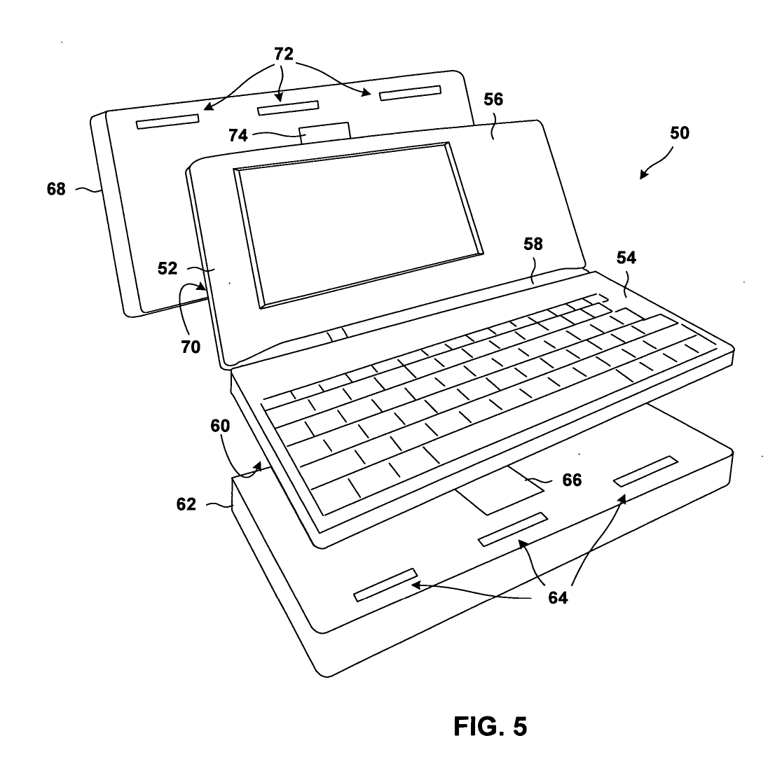

FIG. 5 is a perspective view of a further embodiment of another embodiment of the invention. System 50 includes a portable computer 52 and comprises a first cover member 54 and a second cover member 56 hingedly coupled together by a hinge member 58. Like system 10 shown in FIG. 1, first cover member 54 of system 50 includes an underside 60, and a first power pack 62 couples to underside 60 of first cover member 54. First power pack 62 includes one or more mating elements 64 configured to engage complementary mating elements (not shown) on underside 60. First power pack 62 also includes one or more electrical contacts 66, which electrically couple first power pack 62 to first cover member 54.

A second power pack 68 is configured to couple to the underside 70 of second cover member 56. Second power pack 68 includes one or more mating elements 72 configured to engage complementary mating elements (not shown) on second cover underside 70. Second power pack 68 also includes one or more electrical contacts 74, which electrically couple second power pack 68 to second cover member 56.

As shown in FIG. 5, first and second power packs 62, 68 may be interchangeable, with each power configured to couple to either of first or second cover members 54, 56. The invention also supports embodiments in which the first power pack couples exclusively to the first cover member, and the second power pack couples exclusively to the second cover member.

FIG. 5 also shows power packs 62 and 68 as having different thicknesses. Power packs 62 and 68 may differ in ways other ways as well, having different energy storage capacities, battery chemistries, and so on. The invention also supports embodiments in which power packs 62 and 68 have the same dimensions and the same power pack qualities.

The embodiment depicted in FIG. 5 can be useful for users that wish to use their portable computers for very long periods of time and who desire extensive energy storage capacity. Extensive energy storage capacity may also be desirable when users desire to power one or more peripheral devices with system 50. The embodiment of FIG. 5 is also useful for users that wish to combine the advantages of various use power packs. For example, first power pack may have extensive energy storage capacity and second power pack may be solar-powered, and may further be configured to recharge the first power pack.

The various embodiments of the invention may have one or more advantages. In general, the user can select the power pack or power packs that are able to meet the user's needs. When the user requires a longer power pack life, the user can select a power pack that has a large energy storage capacity. When the user requires a power pack that saves space, the user can select a power pack that is thin. When the user requires a power pack that can operate on solar power, the user can select a power pack that includes solar cells, and so on.

Various embodiments of the invention have been described. These and other embodiments are within the scope of the following claims.

1. A system comprising:
a portable computer comprising a first cover member hingedly coupled to a second cover member,
a first power pack; and
a second power pack,
wherein the first and second power packs are configured to detachably electrically couple to the underside of the first cover member and wherein the first power pack is thicker than the second power pack.

2. The system of claim 1, further comprising a third power configured to detachably electrically couple to the underside of the second cover member.

3. The system of claim 1 wherein the fist power pack includes at least one spacer configured to extend away firm an underside of the first power pack.

4. A system comprising:
a portable computer comprising a first cover member hingedly coupled to a second cover member;
a first power pack comprising a first power pack quality; and
a second power pack comprising a second power pack quality,
wherein the first and second power packs are configured to detachably electrically couple to the underside of the first cover member.

5. The system of claim 5, further comprising a third power pack configured to detachably electrically couple to the underside of the second cover member.

6. The system of claim 5, wherein the first power pack quality is different than the second power pack quality in rewards to at least one of energy storage capacity, energy management, rechargeability, or environmental operating specifications.

7. A system comprising:
a portable computer comprising a first cover member hingedly coupled to a second cover member;
a first power pack configured to detachably electrically couple to the underside of the first cover member; and
a second power pack configured to detachably electrically couple to the underside of the second cover member.

8. The system of claim 7, wherein the first power pack comprises a first power pack quality and the second power pack comprises a second power pack quality.
